(19) United States
(12) Patent Application Publication
(10) Pub. No.: US 2016/0154522 A1
(43) Pub. Date: Jun. 2, 2016

(54) FIELD SHAPING TOUCH SENSOR

(71) Applicant: Apple Inc., Cupertino, CA (US)

(72) Inventors: Shahrooz SHAHPARNIA, Monte Sereno, CA (US); Marduke YOUSEFPOR, San Jose, CA (US)

(21) Appl. No.: 15/014,884

(22) Filed: Feb. 3, 2016

Related U.S. Application Data
(62) Division of application No. 13/624,674, filed on Sep. 21, 2012, now abandoned.

(51) Int. Cl. G06F 3/041; G06F 3/044; G06F 3/047

(52) U.S. Cl. CPC G06F 3/0416; G06F 3/047; G06F 3/044; G06F 2203/04108

(57) ABSTRACT

Touch sensors for detecting touch and hover events are disclosed. The touch sensors can include multiple split sense lines and/or multiple split drive lines. The split sense lines and/or split drive lines can include uniformly or non-uniformly spaced prongs. In some examples, the prongs can include uniformly or non-uniformly spaced extensions extending away from the prongs. The prongs and/or extensions can be interleaved with prongs and/or extensions of adjacent drive lines or sense lines.

### CROSS-REFERENCE TO RELATED APPLICATIONS

This application is a divisional of U.S. patent application Ser. No. 13/624,674 (now U.S. Publication No. 2014/0085211), filed Sep. 21, 2012, the entire disclosure of which is incorporated herein by reference for all purposes.

### FIELD

This relates generally to touch panels and, more specifically, to field-shaping touch sensors.

### BACKGROUND

Touch sensitive devices have become popular as input devices to computing systems due to their ease and versatility of operation as well as their declining price. A touch sensitive device can include a touch sensor panel, which can be a clear panel with a touch sensitive surface, and a display device, such as a liquid crystal display (LCD), that can be positioned partially or fully behind the panel or integrated with the panel so that the touch sensitive surface can cover at least a portion of the viewable area of the display device. The touch sensitive device can allow a user to perform various functions by touching the touch sensor panel using a finger, stylus or other object at a location often dictated by a user interface (UI) being displayed by the display device. In general, the touch sensitive device can recognize a touch or hover event and the position of the touch or hover event on the touch sensor panel, and the computing system can then interpret the touch or hover event in accordance with the display appearing at the time of the touch or hover event, and thereafter can perform one or more actions based on the touch or hover event.

When the object touching or hovering over the touch sensor panel is small relative to the sensor pitch of the touch sensor, touch or hover signals indicative of a touch or hover event can be erroneous or distorted.

### SUMMARY

Touch sensors for detecting touch and hover events are disclosed. The touch sensors can include multiple split sense lines and/or multiple split drive lines. The split sense lines and/or split drive lines can include uniformly or non-uniformly spaced prongs. In some examples, the prongs can include uniformly or non-uniformly spaced extensions extending away from the prongs. The prongs and/or extensions can be interleaved with prongs and/or extensions of adjacent drive lines or sense lines.

### BRIEF DESCRIPTION OF THE DRAWINGS

FIG. 1 illustrates an exemplary touch sensor that can be used with a touch sensitive device according to various examples.

FIG. 2 illustrates an exemplary touch sensor according to various examples.

FIG. 3 illustrates exemplary capacitance values detected by a touch sensor according to various examples.

FIG. 4 illustrates exemplary capacitance values detected by a touch sensor according to various examples.

FIG. 5 illustrates another exemplary touch sensor having split sense lines according to various examples.

FIG. 6 illustrates another exemplary touch sensor having split sense lines according to various examples.

FIG. 7 illustrates another exemplary touch sensor having non-uniformly spaced split sense lines according to various examples.

FIG. 8 illustrates another exemplary touch sensor having split sense lines with interleaved extensions according to various examples.

FIG. 9 illustrates another exemplary touch sensor having split sense lines with interleaved extensions according to various examples.

FIG. 10 illustrates another exemplary touch sensor having interleaved split sense lines according to various examples.

FIG. 11 illustrates another exemplary touch sensor having non-uniformly interleaved split sense lines according to various examples.

FIG. 12 illustrates an exemplary process for detecting an object using a touch sensor according to various examples.

FIG. 13 illustrates an exemplary system for detecting an object using a touch sensor according to various examples.

FIG. 14 illustrates an exemplary personal device that includes a touch sensor according to various examples.

FIG. 15 illustrates another exemplary personal device that includes a touch sensor according to various examples.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

This relates to touch sensors for touch sensitive devices. The touch sensors can include multiple split sense lines and/or multiple split drive lines. The split sense lines and/or split drive lines can include uniformly or non-uniformly spaced prongs. In some examples, the prongs can include uniformly or non-uniformly spaced extensions extending away from the prongs. The prongs and/or extensions can be interleaved with prongs and/or extensions of adjacent drive lines or sense lines.

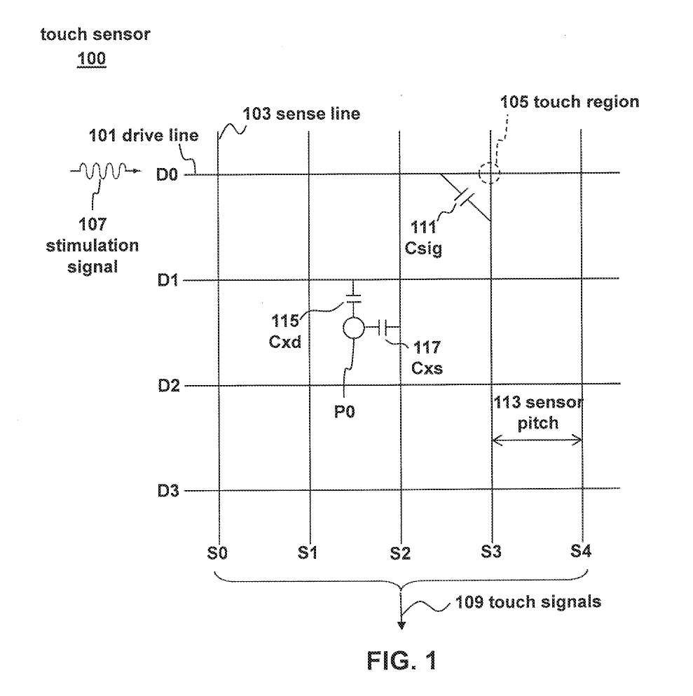

FIG. 1 illustrates touch sensor 100 that can be used to detect touch or hover events on or near a touch sensitive device, such as a mobile phone, tablet, touchpad, portable computer, portable media player, or the like. Touch sensor 100 can include an array of touch regions 105 that can be formed at the crossing points between rows of drive lines 101 (D0-D3) and columns of sense lines 103 (S0-S4). Each touch region 105 can have an associated mutual capacitance Csig 111 formed between the crossing drive lines 101 and sense lines 103 when the drive lines are stimulated. The drive lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or a fewer number of sense amplifiers that can be multiplexed to connect to a larger number of sense lines.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When a user's finger (or other object) touches the touch sensor 100, the finger can cause the capacitance Csig 111 to reduce by an amount ΔCsig at the touch location. This capacitance change ΔCsig can be caused by charge or current from the stimulated drive line 101 being shunted through the touching finger to ground rather than being coupled to the crossing sense line 103 at the touch location. The touch signals 109 representative of the capacitance change ΔCsig can be transmitted by the sense lines 103 to the sense circuitry for processing. The touch signals 109 can indicate the touch region where the touch occurred and the amount of touch that occurred at that touch region location. In some examples, an external object, such as a stylus, can be an “active” object, meaning that it can include drive circuitry to inject current into the sense lines 103 or drive lines 101. In these examples, the external object can have coupling capacitances to sense line 103 and drive lines 101. For example, when the external object is placed at P0, a capacitance of Cxd 115 can be formed between the external object to a drive line (e.g., drive line D1) and a capacitance of Cxs 117 can be formed between the external object and a sense line (e.g., sense line S2).

While the example shown in FIG. 1 includes four drive lines 101 and five sense lines 103, it should be appreciated that touch sensor 100 can include any number of drive lines 101 and any number of sense lines 103 to form the desired number and pattern of touch regions 105. Additionally, while the drive lines 101 and sense lines 103 are shown in FIG. 1 in a crossing configuration, it should be appreciated that other configurations are also possible to form the desired touch region pattern. While FIG. 1 illustrates mutual capacitance touch sensing, other touch sensing technologies may also be used in conjunction with examples of the disclosure, such as self-capacitance touch sensing, resistive touch sensing, projection scan touch sensing, and the like. Furthermore, while various examples describe a sensed touch, it should be appreciated that the touch sensor 100 can also sense a hovering object and generate hover signals therefrom. Additionally, touch sensor 100 can be used to detect an active object operable to drive a signal into touch sensor 100, as described above.

As mentioned above, touch sensor 100 can be used to detect touch and hover events on or near the surface of touch sensor 100. Typically, touch sensor 100 can be designed to have sensor pitch 113 (e.g., spacing between sense lines 103) such that multiple sense lines 103 can be located beneath an object on or near the surface of touch sensor 100. For example, bulky objects, such as a user's finger or a blunt-point stylus can typically be used to interact with touch-sensitive devices. As such, a sensor pitch of approximately 5 mm can be used such that multiple sense lines 103 are located beneath the user's finger or the stylus to detect the touch or hover event, thereby improving the accuracy of touch sensor 100.

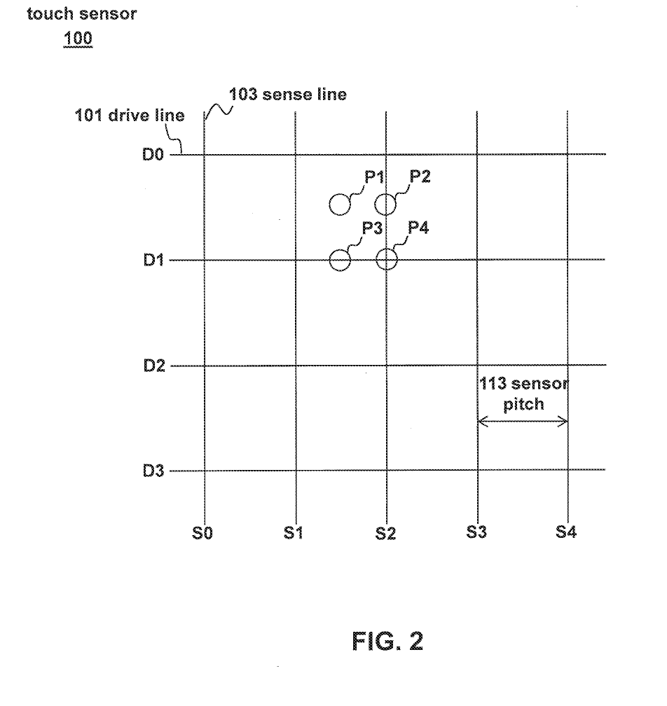

A problem arises, however, when the size of the object interacting with touch sensor 100 is smaller than the sensor pitch 113 (e.g., when using a fine-point stylus). This problem is illustrated in FIG. 2, which shows four example input points P1-P4 located on touch sensor 100. As shown, each input point is smaller than the sensor pitch of touch sensor 100. In these instances, the input point of a touch or hover event will either be located between two sensor lines 103 or above a single sensor line 103. This can cause fewer sense lines 103 to detect a substantial capacitance change ΔCsig, thereby resulting in less than optimal traditional touch or hover detection. In this scenario, if the object interacting with touch sensor 100 includes separate drive circuitry (e.g., an active stylus), the sense current on the sense lines 103 can be dominated by the capacitive coupling between the object and touch sensor 100 through direct injection. More specifically, the sense current on the sense lines 103 can be dominated by the capacitive coupling through Cxd and/or Cxs (shown in FIG. 1). As mentioned above, active objects may have the ability to increase the amount of charge received on a sense line 103 due to their presence. However, the strength of the touch signal 109 detected by a sense line 103 can vary substantially for object locations, such as P1-P4. This variation can impose a high dynamic range requirement on the sense inputs of a sense touch controller integrated circuit (“IC”) in order to satisfy a minimum signal to noise ratio required to accurately find the object's position.

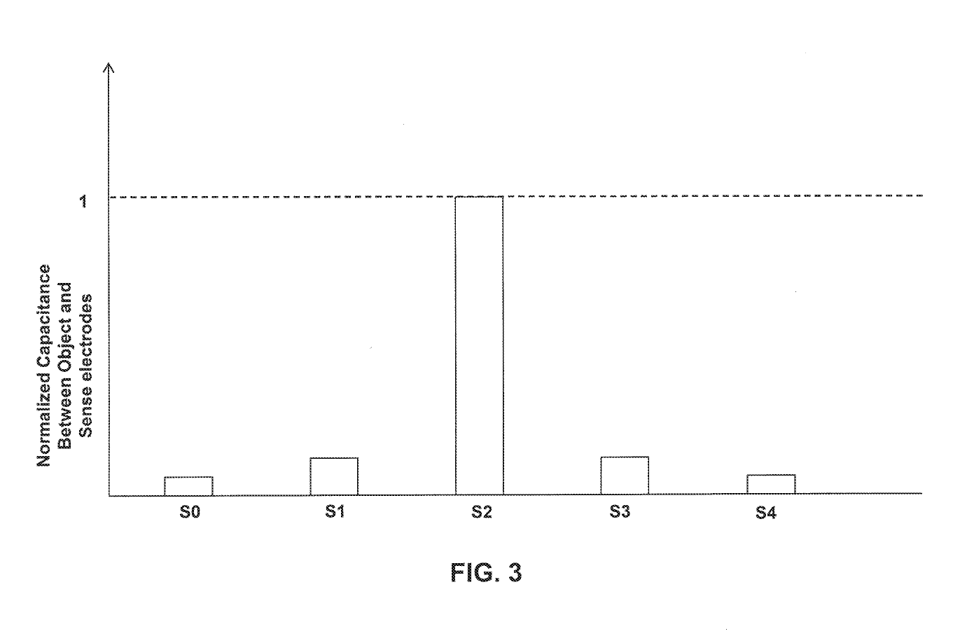

To further illustrate this problem, FIG. 3 shows example capacitances formed between an object located at either input point P2 or P4 and each of the sense lines S0-S4. Specifically, in the configuration shown in FIG. 2, the capacitance formed between an object located at either input point P2 or P4 and sense line S2 can be approximately equal to K/t, where K is a constant and t is a thickness of a cover glass positioned over touch sensor 100 (e.g., approximately equal to a vertical distance between the object and sense line S2). The capacitance between the object located at either input point P2 or P4 and sense line S1 and S3 can be approximately equal to K/sqrt(t²+Δx²), where K is a constant, t is the thickness of the cover glass, Δx is the lateral distance between each sense line S0-S4 (sensor pitch 113), and sqrt is the square root function. The capacitance between the object located at either input point P2 or P4 and sense line S0 and S4 is approximately equal to K/sqrt(t²+4Δx²), where K is a constant, t is the thickness of the cover glass, Δx is the lateral distance between each sense line S0-S4, and sqrt is the square root function. As can be seen in FIG. 3, there is a rapid fall-off in capacitance formed between the object and sense line S2 and the capacitance formed between the object and sense lines S1 and S3. Depending on the thickness of the cover glass and the distance between sensor lines S0-S4, the ratio between the capacitance formed between the object and sense line S2 and the capacitance formed between the object and adjacent side sense lines S1 and S3 can be between 5-10. This ratio between capacitances of adjacent lines may be referred to herein as a “dynamic range metric.” It can be desirable to have a more gradual fall-off from the capacitance formed between the object and the sense line(s) nearest the touch (or active object) input location, such that the dynamic range metric is reduced or minimized. Reducing or minimizing this metric increases or maximizes the signal to noise ratio for a given receiver channel. Reducing this ratio, in addition, causes a more smooth change in mutual capacitance between the stylus tip and the adjacent electrode, as the tip moves from the top of an electrode to a position between two electrodes. This increases linearity and positional accuracy as the stylus moves across the electrodes. For example, in some instances, it can be desirable to have a dynamic range metric between 1 and 6 (e.g., between 2 and 4). The same dynamic range metric objectives can apply to the drive lines D0-D3. However, the dynamic range metric concern for the drive lines is not always as severe because, in some instances, the drive lines have a greater width than the sense lines, thereby providing them with an inherent smaller dynamic range requirement.

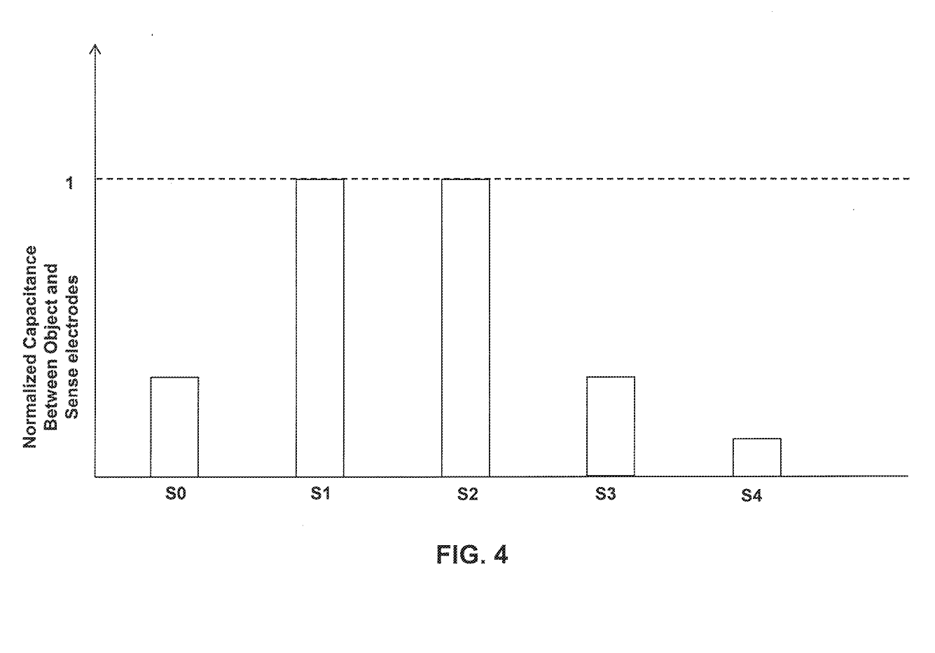

Looking now at input points P1 or P3, FIG. 4 illustrates example capacitances formed between an object located at either input point P1 or P3 and each of the sense lines S0-S4. Specifically, in the configuration shown in FIG. 2, the capacitance between an object located at either input point P1 or P3 and sense lines S1 and S2 can be approximately equal to K/sqrt(t²+Δx²/4), where K is a constant, t is a thickness of the cover glass positioned over touch sensor 100 (e.g., approximately equal to a vertical distance between the object and sense line S2), Δx is the lateral distance between each sense line S0-S4, and sqrt is the square root function. The capacitance between the object located at either input point P1 or P3 and sense line S0 and S3 can be approximately equal to K/sqrt(t²+9Δx²/4), where K is a constant, and t is the thickness of the cover glass, Δx is the lateral distance between each sense line S0-S4, and sqrt is the square root function. As can be seen in FIG. 4, there is a more gradual fall-off in capacitance formed between the object and sense lines S1 and S2 and the capacitance formed between the object and sense lines S0 and S3 than that shown in FIG. 3. Specifically, in this example, the sense line dynamic range metric is approximately equal to 3. In some instances, the sense line dynamic range metric in this example (when the touch or hover event occurs at input points P1 or P3 between sense lines 103) can be acceptable to produce reliable touch or hover detection.

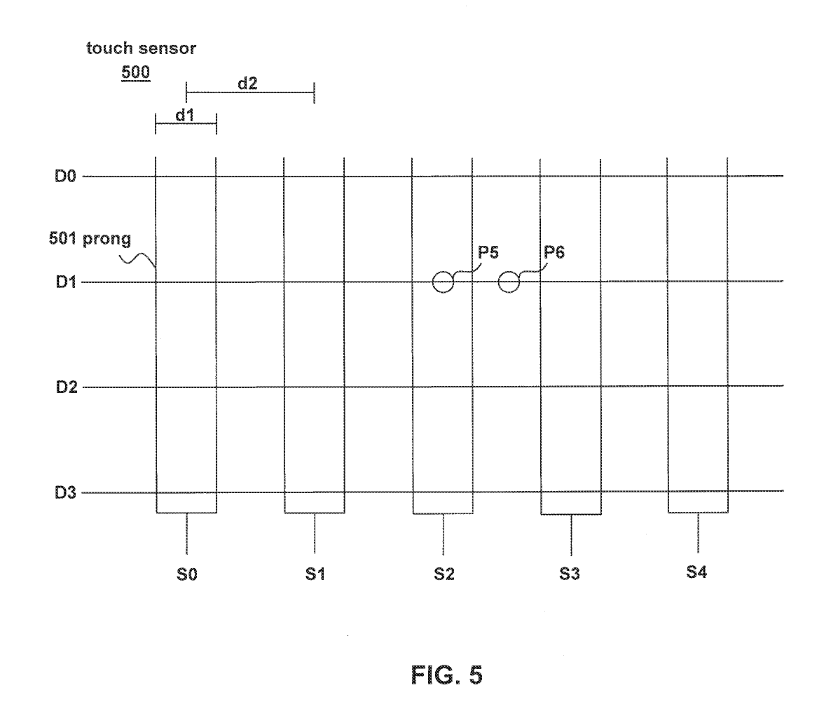

To produce improved touch and hover detection for small objects (e.g., a fine-point stylus), touch sensor designs that have acceptable dynamic range metrics for all input point locations is desired. FIGS. 5-11 illustrate example touch sensor designs that can be used to shape the electric field (and thus control the dynamic range metric at various points on the touch sensor) formed by the touch sensor, thereby achieving desired dynamic range metrics for some or all input point locations on the touch sensor.

FIG. 5 illustrates an exemplary touch sensor 500 that can be used to detect touch or hover events in a manner similar or identical to that described above with respect to touch sensor 100. Touch sensor 500 can include drive lines D0-D3 and sense lines S0-S4, each having a single line split into two prongs 501. This configuration can be used to produce a desired dynamic range metric across the touch sensor surface by shaping the electric field generated by touch sensor 500 to cause more electric field overlap between sense lines S0-S4 (e.g., caused by closer proximity of prongs 501 of adjacent sense lines S0-S4). Drive lines D0-D3 and sense lines S0-S4 can be formed from various conductive materials, such as indium tin oxide (ITO), and can be arranged in various manners, such as a single sided ITO (SITO) configuration in which the drive lines D0-D3 are formed on the same side of the touch sensor substrate as the sense lines S0-S4 or a double-sided ITO (DITO) configuration in which the drive lines D0-D3 are formed on the opposite side of the touch sensor substrate from the sense lines S0-S4. In one example, the distance d1 between prongs 501 can be between 2-3 mm (e.g., 2.5 mm) and the distance d2 between sense lines can be between 4-6 mm (e.g., 5 mm). Using example values of d1=2.5 mm, d2=5 mm, drive line pitch (e.g., distance between drive lines) of 5 mm, and other typical characteristics for a DITO touch sensor and stylus, a sense line dynamic range metric of about 3.79 (e.g., capacitance for S1=29 fF, S2=110 fF, and S3=29 fF) and drive line dynamic range metric of about 4.00 (e.g., capacitance for D0=26 fF, D1=104 fF, and D2=26 fF) can be achieved when the stylus is placed at input point P5 on or near touch sensor 500. A sense line dynamic range metric of about 1.00 (e.g., capacitance for S2=75 fF and S3=75 fF) and a drive line dynamic range metric of about 4.12 (e.g., capacitance for D0=25 fF, D1=103 fF, and D2=25 fF) can be achieved when the stylus is placed at input point P6 on or near touch sensor 500. It should be appreciated that these values are provided only as examples, and that the lengths of the sense lines S0-S4 and drive lines D0-D3, lengths of the prongs 501, number of prongs 501, spacing between prongs 501, and spacing between sense lines S0-S4 and drive lines D0-D3 can be adjusted to other uniform or non-uniform values to produce desired dynamic range metric values.

While the example shown in FIG. 5 includes five sense lines S0-S4, it should be appreciated that touch sensor 500 can include any number of sense lines. Additionally, it should be appreciated that touch sensor 500 can include any number of drive lines similar or identical to drive lines 101 of touch sensor 100.

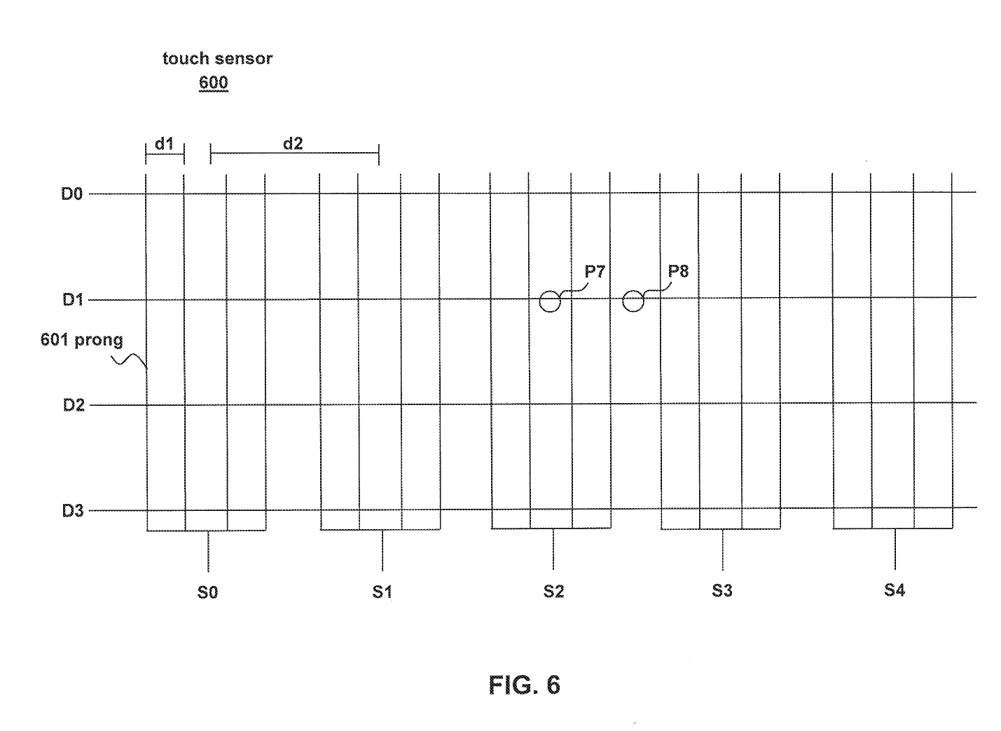

FIG. 6 illustrates another exemplary touch sensor 600 that can be used to detect touch or hover events in a manner similar or identical to that described above with respect to touch sensor 100. In this example, touch sensor 600 includes drive lines D0-D3 and sense lines S0-S4, each having a single line split into four prongs 601. This configuration can be used to produce a desired dynamic range metric across the touch sensor surface by shaping the electric field generated by touch sensor 600 to cause more electric field overlap between sense lines S0-S4 (e.g., caused by closer proximity of prongs 601 of adjacent sense lines S0-S4). Drive lines D0-D3 and sense lines S0-S4 can be formed from various conductive materials, such as ITO, and can be arranged in various manners, such as a SITO configuration or a DITO configuration. In one example, the prongs 601 can be uniformly separated by a distance d1 having a value between 1-1.5 mm (e.g., 1.25 mm). Additionally, sense lines S0-S4 can be uniformly or non-uniformly separated by a distance d2 having a value between 4-6 mm (e.g., 5 mm). Using example values of d1=1.25 mm, d2=5 mm, drive line pitch (e.g., distance between drive lines) of 5 mm, and other typical characteristics for a DITO touch sensor and stylus, a sense line dynamic range metric of about 3.92 (e.g., capacitance for S1=39 fF, S2=153 fF, and S3=39 fF) and drive line dynamic range metric of about 4.06 (e.g., capacitance for D0=16 fF, D1=65 fF, and D2=16 fF) can be achieved when the stylus is placed at input point P7 on or near touch sensor 600. A sense line dynamic range metric of about 1.00 (e.g., capacitance for S2=102 fF and S3=102 fF) and a drive line dynamic range metric of about 4.33 (e.g., capacitance for D0=15 fF, D1=65 fF, and D2=15 fF) can be achieved when the stylus is placed at input point P8 on or near touch sensor 600. It should be appreciated that these values are provided only as examples, and that the lengths of the sense lines S0-S4 and drive lines D0-D3, lengths of the prongs 601, number of prongs 601, spacing between prongs 601, and spacing between sense lines S0-S4 and drive lines D0-D3 can be adjusted to other uniform or non-uniform values to produce desired dynamic range metric values.

While the example shown in FIG. 6 includes five sense lines S0-S4, it should be appreciated that touch sensor 600 can include any number of sense lines. Additionally, it should be appreciated that touch sensor 600 can include any number of drive lines similar or identical to drive lines 101 of touch sensor 100.

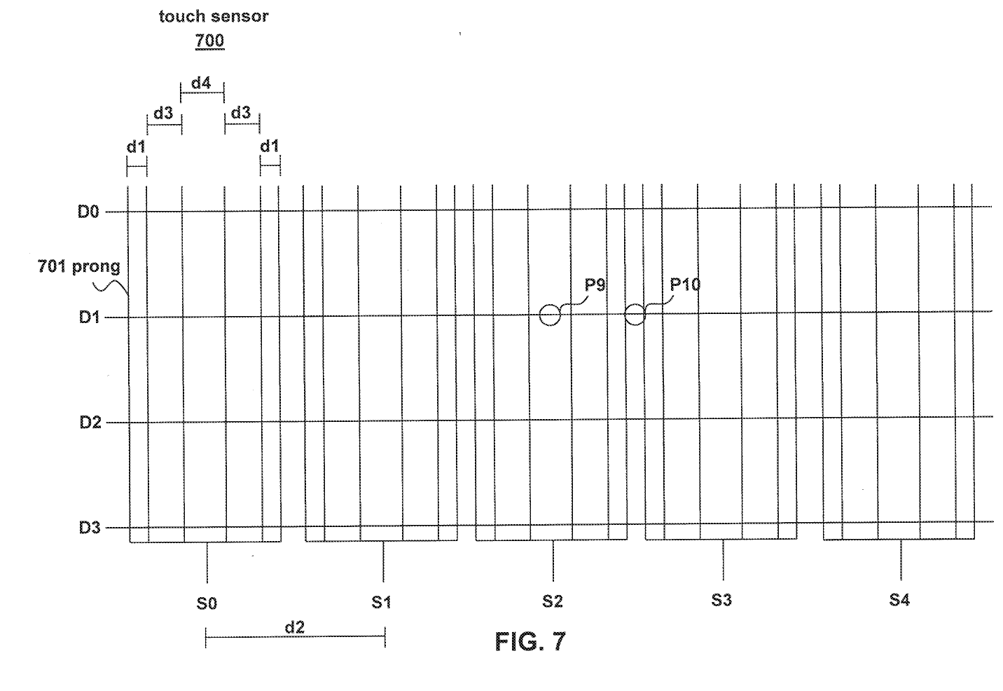

FIG. 7 illustrates another exemplary touch sensor 700 that can be used to detect touch or hover events in a manner similar or identical to that described above with respect to touch sensor 100. Touch sensor 700 is similar to touch sensor 600, except that each sense line S0-S4 of touch sensor 700 is split into six, non-uniformly separated prongs 701. This configuration can be used to produce a desired dynamic range metric across the touch sensor surface by shaping the electric field generated by touch sensor 700 to cause more electric field overlap between sense lines S0-S4 (e.g., caused by closer proximity of prongs 701 of adjacent sense lines S0-S4). In particular, the non-uniform spacing of prongs 701 allows sense lines S0-S4 to detect a capacitance change even when a touch or hover event occurs farther away from the sense line (and close to an adjacent sense line), thereby changing the dynamic range metric. Thus, the spacing between sense lines S0-S4 can be used to control the dynamic range metric at various points on touch sensor 700. In one example, prongs 701 can be non-uniformly separated by distance d1 having a value between 0.5-0.75 mm (e.g., 0.625 mm), distance d3 having a value between 0.5-0.75 mm (e.g., 0.625 mm), and distance d4 having a value between 1-1.5 mm (e.g., 1.25 mm). In some examples, the value of d1 can be less than the value of d3 and the value of d3 can be less than the value of d4. Thus, the density of prongs 701 near the center of each sense line S0-S4 can be less than the density of prongs 701 farther away from the center of each sense line S0-S4. Additionally, sense lines S0-S4 can be uniformly or non-uniformly separated by a distance d2 having a value between 4-6 mm (e.g., 5 mm). Using example values of d1=0.625 mm, d2=5 mm, d3=0.625 mm, d4=1.25 mm, drive line pitch (e.g., distance between drive lines) of 5 mm, and other typical characteristics for a DITO touch sensor and stylus, a sense line dynamic range metric of about 4.14 (e.g., capacitance for S1=44 fF, S2=182 fF, and S3=44 fF) and drive line dynamic range metric of about 4.44 (e.g., capacitance for D0=9 fF, D1=40 fF, and D2=9 fF) can be achieved when the stylus is placed at input point P9 on or near touch sensor 700. A sense line dynamic range metric of about 1.00 (e.g., capacitance for S2=104 fF and S3=104 fF) and a drive line dynamic range metric of about 4.13 (e.g., capacitance for D0=15 fF, D1=62 fF, and D2=15 fF) can be achieved when the stylus is placed at input point P10 on or near touch sensor 700. It should be appreciated that these values are provided only as examples, and that the lengths of the sense lines S0-S4 and drive lines D0-D3, lengths of the prongs 701, number of prongs 701, spacing between prongs 701, and spacing between sense lines S0-S4 and drive lines D0-D3 can be adjusted to other uniform or non-uniform values to produce desired dynamic range metric values.

While the example shown in FIG. 7 includes five sense lines S0-S4, it should be appreciated that touch sensor 700 can include any number of sense lines. Additionally, it should be appreciated that touch sensor 700 can include any number of drive lines similar or identical to drive lines 101 of touch sensor 100.

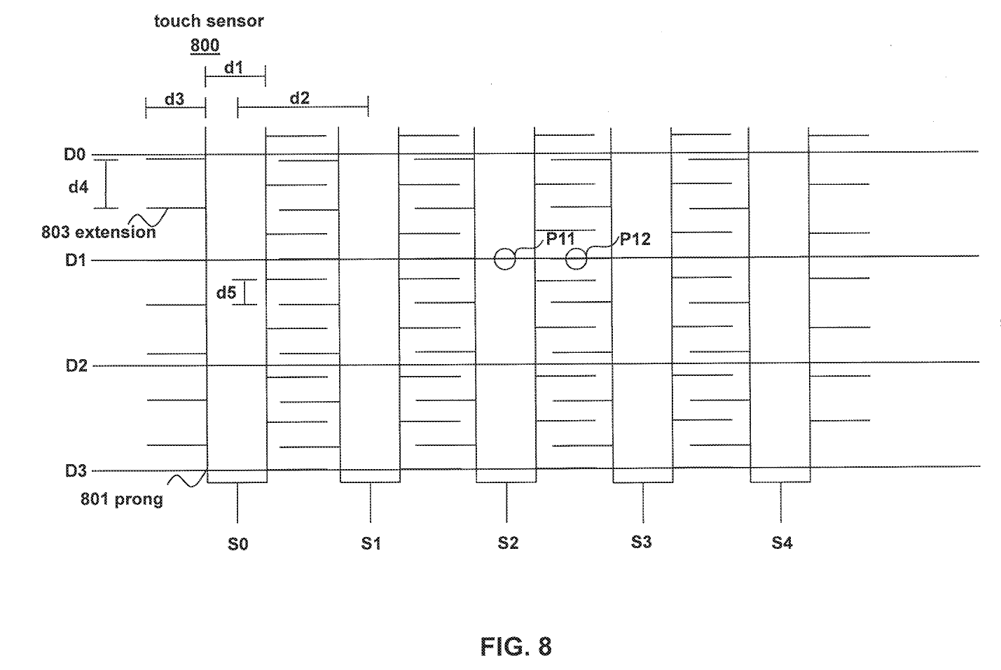

FIG. 8 illustrates another exemplary touch sensor 800 that can be used to detect touch or hover events in a manner similar or identical to that described above with respect to touch sensor 100. Touch sensor 800 can include drive lines D0-D3 and sense lines S0-S4, each having a single line split into two prongs 801. Additionally, each prong 801 can include one or more extensions 803 extending away (e.g., at a perpendicular angle or other angle) from the prong 801. This configuration can be used to produce a desired dynamic range metric across the touch sensor surface by shaping the electric field generated by touch sensor 800 to cause more electric field overlap between sense lines S0-S4 (e.g., caused by closer proximity of prongs 801 of adjacent sense lines S0-S4 and interleaving of extensions 803). In particular, the use of extensions 803 allow sense lines S0-S4 to detect a capacitance change even when a touch or hover event occurs farther away from the sense line (and close to an adjacent sense line), thereby changing the dynamic range metric. Thus, extensions 803 can be used to control the dynamic range metric at various points on touch sensor 800. Drive lines D0-D3 and sense lines S0-S4 can be formed from various conductive materials, such as ITO, and can be arranged in various manners, such as a SITO configuration or a DITO configuration. In one example, the extensions 803 can each have a length d3 having a value between 2-3 mm (e.g., 2.4 mm), the extensions 803 on the same prong 801 can be uniformly or non-uniformly separated by a distance d4 having a value between 4-6 mm (e.g., 5 mm), the extensions 803 on adjacent prongs 801 can be separated by a distance d5 having a value between 2-3 mm (e.g., 2.5 mm), the prongs 801 can be separated by distance d1 having a value between 2-3 mm (e.g., 2.5 mm), and each sense line S0-S4 can be separated by a distance d2 having a value between 4-6 mm (e.g., 5 mm). Using example values of d1=2.5 mm, d2=5 mm, and d3=2.4 mm, d4=5 mm, d5=2.5 mm, drive line pitch (e.g., distance between drive lines) of 5 mm, and other typical characteristics for a DITO touch sensor and stylus, a sense line dynamic range metric of about 3.53 (e.g., capacitance for S1=36 fF, S2=127 fF, and S3=36 fF) and drive line dynamic range metric of about 4.21 (e.g., capacitance for D0=19 fF, D1=80 fF, and D2=19 fF) can be achieved when the stylus is placed at input point P11 on or near touch sensor 800. A sense line dynamic range metric of about 1.09 (e.g., capacitance for S2=110 fF and S3=101 fF) and a drive line dynamic range metric of about 3.06 (e.g., capacitance for D0=18 fF, D1=55 fF, and D2=18 fF) can be achieved when the stylus is placed at input point P12 on or near touch sensor 800. It should be appreciated that these values are provided only as examples, and that the lengths of the sense lines S0-S4 and drive lines D0-D3, lengths of the prongs 801, number of prongs 801, spacing between prongs 801, number of extensions 803, spacing between extensions 803, and spacing between sense lines S0-S4 and drive lines D0-D3 can be adjusted to other uniform or non-uniform values to produce a desired dynamic range metric.

While the example shown in FIG. 8 includes five sense lines S0-S4, it should be appreciated that touch sensor 800 can include any number of sense lines. Additionally, it should be appreciated that touch sensor 800 can include any number of drive lines similar or identical to drive lines 101 of touch sensor 100.

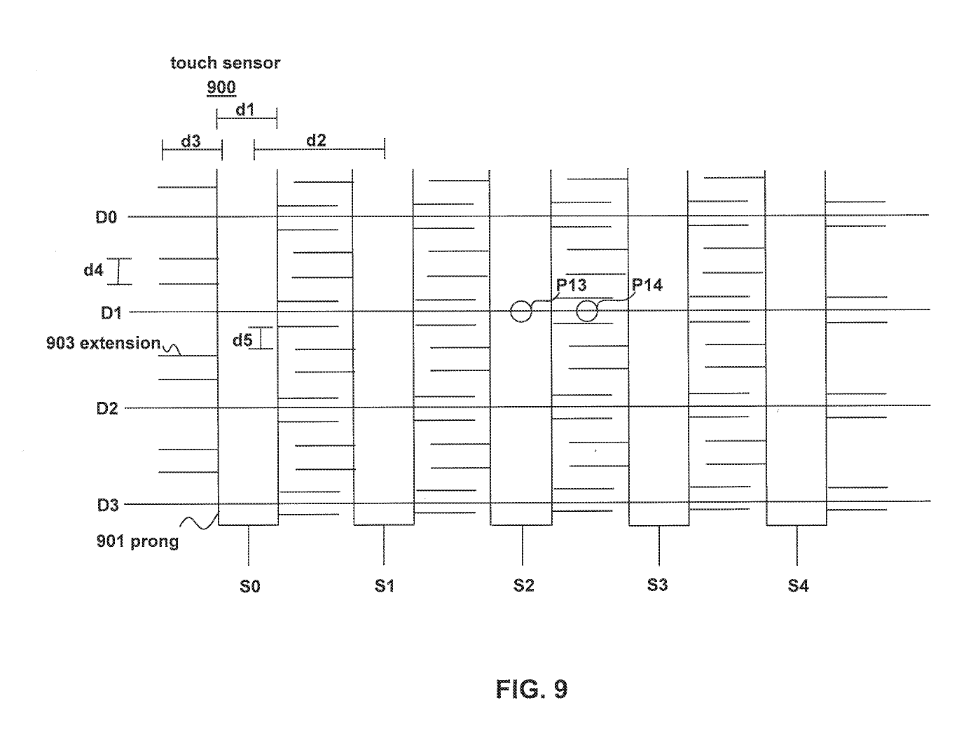

FIG. 9 illustrates another exemplary touch sensor 900 that can be used to detect touch or hover events in a manner similar or identical to that described above with respect to touch sensor 100. Touch sensor 900 can include drive lines D0-D3 and sense lines S0-S4, each having a single line split into two prongs 901. Additionally, each prong 901 can include one or more extensions 903 extending away (e.g., at a perpendicular angle or other angle) from the prong 901. This configuration can be used to produce a desired dynamic range metric across the touch sensor surface by shaping the electric field generated by touch sensor 900 to cause more electric field overlap between sense lines S0-S4 (e.g., caused by closer proximity of prongs 901 of adjacent sense lines S0-S4 and interleaving of pairs of extensions 903). In particular, the use of extensions 903 allow sense lines S0-S4 to detect a capacitance change even when a touch or hover event occurs farther away from the sense line (and close to an adjacent sense line), thereby changing the dynamic range metric. Thus, extensions 903 can be used to control the dynamic range metric at various points on touch sensor 900. Drive lines D0-D3 and sense lines S0-S4 can be formed from various conductive materials, such as ITO, and can be arranged in various manners, such as a SITO configuration or a DITO configuration. In one example, the extensions 903 can each have a length d3 having a value between 2-3 mm (e.g., 2.4 mm), the extensions 903 on the same prong 901 can be uniformly or non-uniformly separated by a distance d4 having a value between 1-3 mm (e.g., 2 mm), the extensions 903 on adjacent prongs 901 can be separated by a distance d5 having a value between 1-3 mm (e.g., 2 mm), the prongs 901 can be separated by distance d1 having a value between 2-3 mm (e.g., 2.5 mm), and each sense line S0-S4 can be separated by a distance d2 having a value between 4-6 mm (e.g., 5 mm). Using example values of d1=2.5 mm, d2=5 mm, and d3=2.4 mm, d4=2 mm, d5=2 mm, drive line pitch (e.g., distance between drive lines) of 5 mm, and other typical characteristics for a DITO touch sensor and stylus, a sense line dynamic range metric of about 3.25 (e.g., capacitance for S1=40 fF, S2=130 fF, and S3=40 fF) and drive line dynamic range metric of about 4.47 (e.g., capacitance for D0=17 fF, D1=76 fF, and D2=17 fF) can be achieved when the stylus is placed at input point P13 on or near touch sensor 900. A sense line dynamic range metric of about 1.20 (e.g., capacitance for S2=118 fF and S3=98 fF) and a drive line dynamic range metric of about 3.31 (e.g., capacitance for D0=16 fF, D1=53 fF, and D2=16 fF) can be achieved when the stylus is placed at input point P14 on or near touch sensor 900. It should be appreciated that these values are provided only as examples, and that the lengths of the sense lines S0-S4 and drive lines D0-D3, lengths of the prongs 901, number of prongs 901, spacing between prongs 901, number of extensions 903, spacing between extensions 903, and spacing between sense lines S0-S4 and drive lines D0-D3 can be adjusted to other uniform or non-uniform values to produce a desired dynamic range metric.

While the example shown in FIG. 9 includes five sense lines S0-S4, it should be appreciated that touch sensor 900 can include any number of sense lines. Additionally, it should be appreciated that touch sensor 900 can include any number of drive lines similar or identical to drive lines 101 of touch sensor 100.

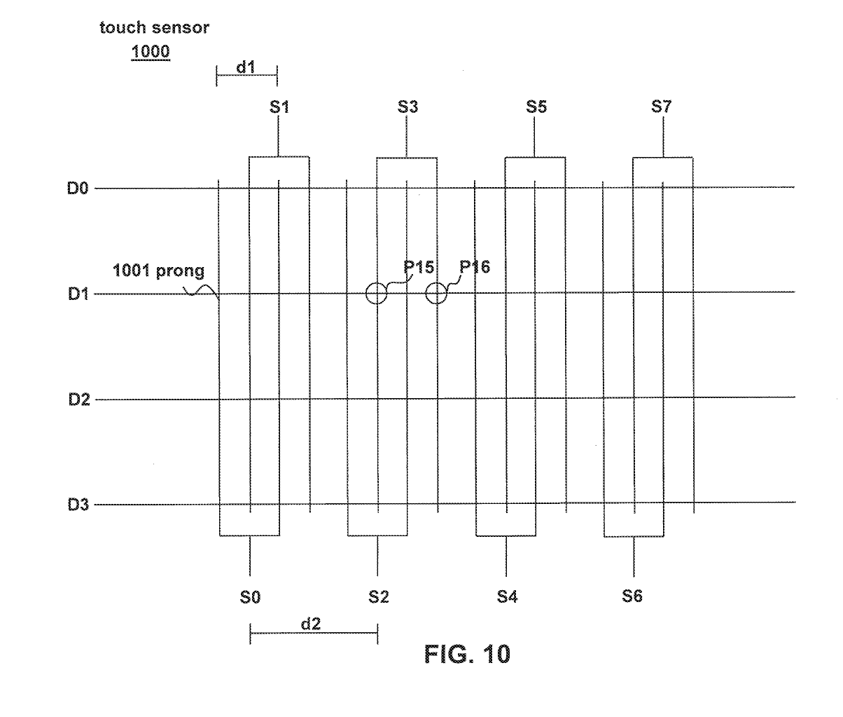

FIG. 10 illustrates an exemplary touch sensor 1000 that can be used to detect touch or hover events in a manner similar or identical to that described above with respect to touch sensor 100. Touch sensor 1000 can include drive lines D0-D3 and sense lines S0-S7, each having a single line split into two prongs 1001. Additionally, sense lines S0-S7 can alternatingly originate from opposite ends of touch sensor 1000. For example, the single line of sense line S0 can originate from an end of touch sensor 1000 opposite that of the single line of adjacent sense line S1. Additionally, prongs 1001 of sense lines S0 and S1 (and similarly S2 and S3, S4 and S5, and S6 and S7) can be interleaved (e.g., overlapping prongs 1001 of different sense lines such that a prong 1001 of a first sense line S0-S7 is located between prongs 1001 of a second sense line S0-S7) as shown in FIG. 10. In some examples, interleaved prongs 1001 of adjacent sense lines S0-S7 can be centered between the prongs of the paired sense lines S0-S7. This configuration can be used to produce a desired dynamic range metric across the touch sensor surface by shaping the electric field generated by touch sensor 1000 to cause more electric field overlap between sense lines S0-S7 (e.g., caused by the interleaving of prongs 1001 of adjacent sense lines S0-S7). Drive lines D0-D3 and sense lines S0-S7 can be formed from various conductive materials, such as ITO, and can be arranged in various manners, such as a SITO configuration or a DITO configuration. In one example, prongs 1001 can be separated by a distance d1 having a value between 2-3 mm (e.g., 2.5 mm) and sense lines S0-S7 can be separated by a distance d2 having a value between 4-6 mm (e.g., 5 mm). Using example values of d1=2.5 mm, d2=5 mm, drive line pitch (e.g., distance between drive lines) of 5 mm, and other typical characteristics for a DITO touch sensor and stylus, a sense line dynamic range metric of about 4.14 (e.g., capacitance for S0=22 fF, S2=91 fF, and S4=22 fF) for sense line S2, sense line dynamic range metric of about 2.76 (e.g., capacitance for S1=33 fF, S3=91 fF, and S5=16 fF) for sense line S3, and drive line dynamic range metric of about 4.33 (e.g., capacitance for D0=15 fF, D1=65 fF, and D2=15 fF) can be achieved when the stylus is placed at input point P15 on or near touch sensor 1000. A sense line dynamic range metric of about 1 (e.g., capacitance for S2=50 fF and S4=50 fF) for sense line S2, sense line dynamic range metric of about 2.76 (e.g., capacitance for S3=33 fF and S5=91 fF) for sense line S3, and drive line dynamic range metric of about 4.33 (e.g., capacitance for D0=15 fF, D1=65 fF, and D2=15 fF) can be achieved when the stylus is placed at input point P16 on or near touch sensor 1000. It should be appreciated that these values are provided only as examples, and that the lengths of the sense lines S0-S7 and drive lines D0-D3, lengths of the prongs 1001, number of prongs 1001, spacing between prongs 1001 of the same sense line S0-S7, spacing between interleaved prongs 1001 of sense lines S0-S7, and spacing between sense lines S0-S7 and drive lines D0-D3 can be adjusted to other uniform or non-uniform values to produce a desired dynamic range metric.

While the example shown in FIG. 10 includes eight sense lines S0-S7, it should be appreciated that touch sensor 1000 can include any number of sense lines. Additionally, it should be appreciated that touch sensor 1000 can include any number of drive lines similar or identical to drive lines 101 of touch sensor 100.

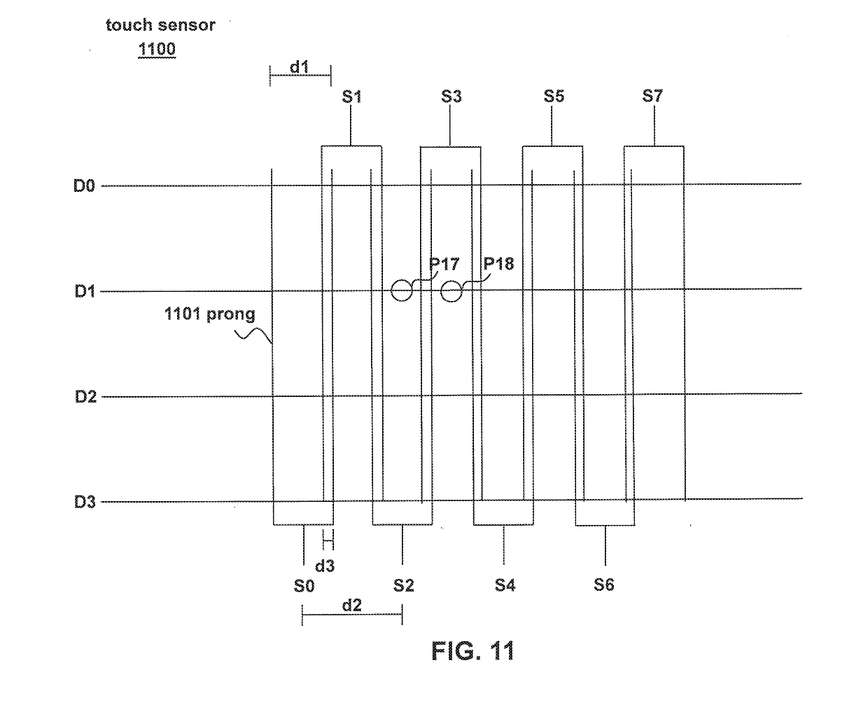

FIG. 11 illustrates an exemplary touch sensor 1100 that can be used to detect touch or hover events in a manner similar or identical to that described above with respect to touch sensor 100. Touch sensor 1100 can be similar to touch sensor 1000, except that prongs 1101 of sense lines S0-S7 can be interleaved with prongs 1101 of each adjacent sense line S0-S7 rather than only a paired sense line S0-S7. Additionally, interleaved prongs 1101 may or may not be centered between prongs 1101 of adjacent sense lines S0-S7. This configuration can be used to produce a desired dynamic range metric across the touch sensor surface by shaping the electric field generated by touch sensor 1100 to cause more electric field overlap between sense lines S0-S7 (e.g., caused by the interleaving of prongs 1101 of adjacent sense lines S0-S7). Drive lines D0-D3 and sense lines S0-S4 can be formed from various conductive materials, such as ITO, and can be arranged in various manners, such as a SITO configuration or a DITO configuration. In one example, prongs 1101 can be separated by a distance d1 having a value between 2-4 mm (e.g., 3 mm), sense lines S0-S7 can be separated by a distance d2 having a value between 4-6 mm (e.g., 5 mm), and prongs 1101 of adjacent, interleaving sense lines S0-S7 can be separated by a distance d3 having a value between 0.25-0.75 mm (e.g., 0.5 mm). Using example values of d1=3 mm, d2=5 mm, d3=0.5 mm, drive line pitch (e.g., distance between drive lines) of 5 mm, and other typical characteristics for a DITO touch sensor and stylus, a sense line dynamic range metric of about 2.76 (e.g., capacitance for S0=21 fF, S2=58 fF, and S4=21 fF) for sense line S2, a sense line dynamic range metric of about 1 (e.g., capacitance for S1=56 and S3=56) for sense line S3, and a drive line dynamic range metric of about 3.82 (e.g., capacitance for D0=17 fF, D1=65 fF, and D2=17 fF) can be achieved when the stylus is placed at input point P17 on or near touch sensor 1100. A sense line dynamic range metric of about 1.00 (e.g., capacitance for S2=56 and S4=56) for sense line S2, a sense line dynamic range metric of 2.76 (e.g., capacitance for S1=21 fF, S3=58 fF, and S5=21 fF) for sense line S3, and a drive line dynamic range metric of about 3.82 (e.g., capacitance for D0=17 fF, D1=65 fF, and D2=17 fF) can be achieved when the stylus is placed at input point P18 on or near touch sensor 1100. It should be appreciated that these values are provided only as examples, and that the lengths of the sense lines S0-S7 and drive lines D0-D3, lengths of the prongs 1101, number of prongs 1101, spacing between prongs 1101 of the same sense line S0-S7, spacing between interleaved prongs 1101 of sense lines S0-S7, and spacing between sense lines S0-S7 and drive lines D0-D3 can be adjusted to other uniform or non-uniform values to produce a desired dynamic range metric.

While the example shown in FIG. 11 includes eight sense lines S0-S7, it should be appreciated that touch sensor 1100 can include any number of sense lines. Additionally, it should be appreciated that touch sensor 1100 can include any number of drive lines similar or identical to drive lines 101 of touch sensor 100.

Moreover, it should be appreciated that the features described above with respect to FIGS. 5-11 can be combined in any manner to form a touch sensor operable to produce a desired dynamic range metric. For example, the sense lines S0-S4 having uniformly spaced prongs 601 of touch sensor 600 can be modified to include extensions similar or identical to extensions 803 of touch sensor 800. Any number of the features described above with respect to FIGS. 5-11 can be combined into a single touch sensor.

While the examples provided above relate to touch sensors in a DITO configuration, it should be appreciated that the concepts disclosed herein can also be applied to SITO structures. For example, in a SITO structure, the drive lines can be patterned in a manner similar to that described above for the sense lines, resulting in a similar improvement in drive line dynamic range metrics.

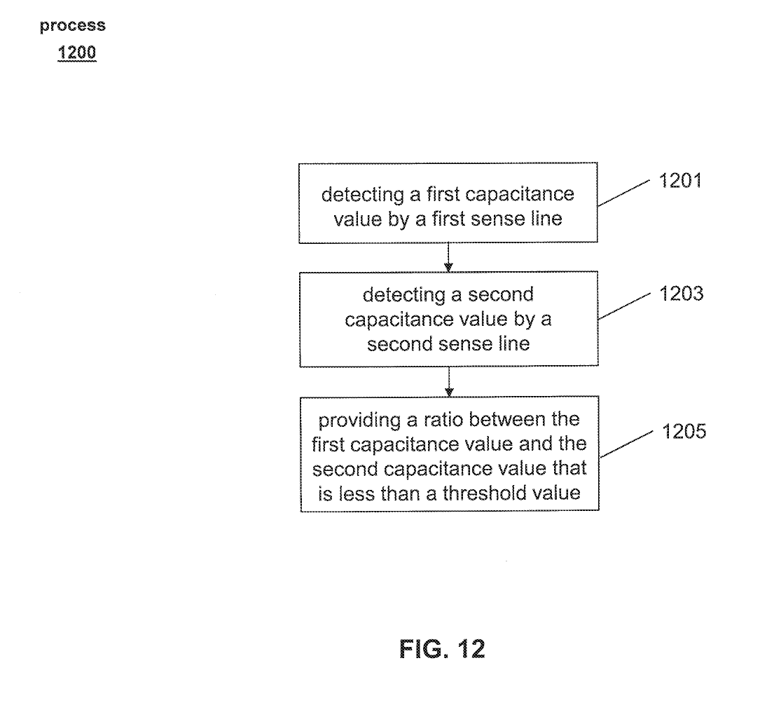

FIG. 12 illustrates an exemplary process 1200 for detecting an object using a touch sensor similar or identical to any of the touch sensors described above. At block 1201, a first capacitance value can be detected using a first sense line as described above with respect to FIG. 1. The first capacitance value can be indicative of a proximity of the object to the touch sensor. The first sense line can include any of the sense lines described above with respect to FIGS. 1, 2, and 5-11.

At block 1203, a second capacitance value can be detected using a second sense line as described above with respect to FIG. 1. The second capacitance value can be indicative of a proximity of the object to the touch sensor. The second sense line can be the same or different than the first sense line. In some examples, the second sense line can include any of the sense lines described above with respect to FIGS. 1, 2, and 5-11. The first sense line can be adjacent to the second sense line.

At block 1205, a ratio between the first and second capacitance values can be provided. In some examples, when the object is located between the first and second sense line, the ratio between the first capacitance and the second capacitance (e.g., dynamic range metric) can be less than a threshold value (e.g., less than 5, less than 4, or less than 3). Using the first capacitance and the second capacitance, a position of the object on or near the touch sensor can be determined.

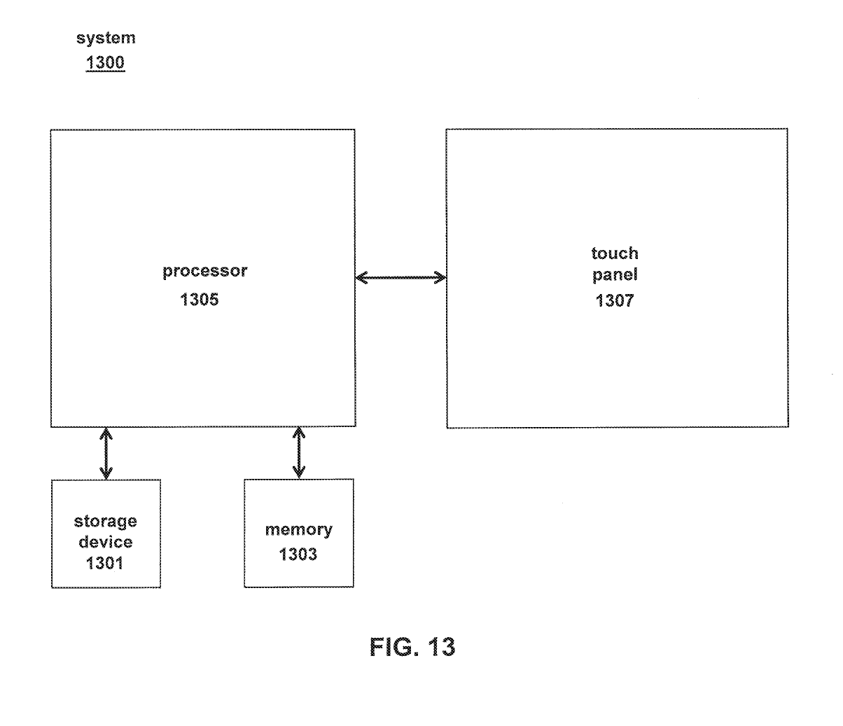

One or more of the functions relating to the detection of an object using a touch sensor described above can be performed by a system similar or identical to system 1300 shown in FIG. 13. System 1300 can include instructions stored in a non-transitory computer readable storage medium, such as memory 1303 or storage device 1301, and executed by processor 1305. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

System 1300 can further include touch panel device 1307 coupled to processor 1305. Touch panel 1307 can include a touch sensor similar or identical to those described above with respect to FIGS. 1, 2, and 5-11 and sense circuitry, which can include a sense amplifier for each sense line, or a fewer number of sense amplifiers that can be multiplexed to connect to a larger number of sense lines. Processor 1305 can be coupled to receive and output from the sense circuitry and process the output to detect touch or hover events.

It is to be understood that the system is not limited to the components and configuration of FIG. 13, but can include other or additional components in multiple configurations according to various example s. Additionally, the components of system 1300 can be included within a single device, or can be distributed between multiple devices. In some examples, processor 1305 can be located within touch panel 1307.

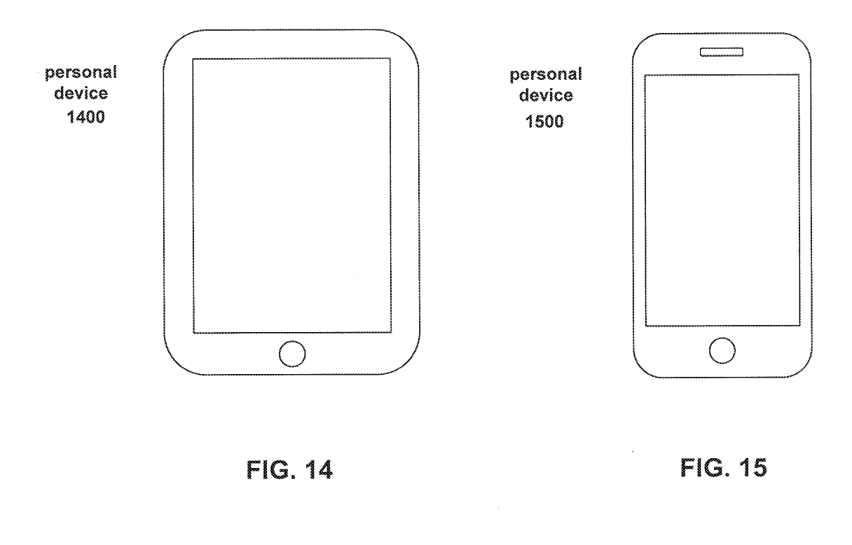

FIG. 14 illustrates an exemplary personal device 1400, such as a tablet, that can include a touch sensor according to various examples.

FIG. 15 illustrates another exemplary personal device 1500, such as a mobile phone, that can include a touch sensor according to various examples.

Therefore, according to the above, some examples of the disclosure are directed to a touch panel comprising: a first sense line split into a first plurality of lines; and a second sense line split into a second plurality of lines, wherein at least one of the first plurality of lines can be interleaved with at least one of the second plurality of lines. Additionally or alternatively to one or more of the examples disclosed above, the first sense line can be split lengthwise into the first plurality of lines. Additionally or alternatively to one or more of the examples disclosed above, the first plurality of lines can be coupled together at a first distal end, and the second plurality of lines can be coupled together at a second distal end. Additionally or alternatively to one or more of the examples disclosed above, the first distal end can be located opposite the second distal end. Additionally or alternatively to one or more of the examples disclosed above, each of the first plurality of lines and second plurality of lines can be uniformly spaced. Additionally or alternatively to one or more of the examples disclosed above, the touch panel can further include: a third sense line split into a third plurality of lines, wherein at least one of the second plurality of lines can be interleaved with at least one of the third plurality of lines.

Some examples of the disclosure are directed to a touch panel comprising: a first sense line split into a first plurality of lines, wherein at least one of the first plurality of lines can include a first plurality of extensions extending away from the at least one of the first plurality of lines. Additionally or alternatively to one or more of the examples disclosed above, the touch panel can further include a second sense line split into a second plurality of lines, wherein at least one of the second plurality of lines can include a second plurality of extensions extending away from the at least one of the second plurality of lines, and wherein the second plurality of extensions can be interleaved with the first plurality of extensions. Additionally or alternatively to one or more of the examples disclosed above, each of the interleaved first plurality of extensions and second plurality of extensions can be uniformly spaced. Additionally or alternatively to one or more of the examples disclosed above, the first plurality of extensions can extend away from the at least one of the first plurality of lines at a perpendicular angle, and the second plurality of extensions can extend away from the at least one of the second plurality of lines at a perpendicular angle.

Some examples of the disclosure are directed to a touch panel comprising: a first drive line operable to receive a first stimulation signal, wherein the first drive line can be divided lengthwise into a first plurality of lines; and a sense line operable to generate a sense signal in response to the first stimulation signal. Additionally or alternatively to one or more of the examples disclosed above, the touch panel can further include: a second drive line operable to receive a second stimulation signal, wherein the second drive line can be divided lengthwise into a second plurality of lines. Additionally or alternatively to one or more of the examples disclosed above, the first plurality of lines can be coupled together at a first distal end and the second plurality of lines can be coupled together at a second distal end. Additionally or alternatively to one or more of the examples disclosed above, the first distal end can be located opposite the second distal end. Additionally or alternatively to one or more of the examples disclosed above, at least one of the first plurality of lines can be interleaved with at least one of the second plurality of lines. Additionally or alternatively to one or more of the examples disclosed above, the sense line can be split lengthwise into a third plurality of lines.

Some examples of the disclosure are directed to a touch panel comprising: a first sense line split into a first plurality of non-uniformly spaced lines; and a second sense line split into a second plurality of non-uniformly spaced lines. Additionally or alternatively to one or more of the examples disclosed above, the first plurality of non-uniformly spaced lines can include four or more lines and the second plurality of non-uniformly spaced lines can include four or more lines. Additionally or alternatively to one or more of the examples disclosed above, a density of the first plurality of non-uniformly spaced lines can be higher near the edges of the first sense line than at a center of the first sense line, and a density of the second plurality of non-uniformly spaced lines can be higher near the edges of the second sense line than at a center of the second sense line. Additionally or alternatively to one or more of the examples disclosed above, the touch panel can further include a plurality of drive lines capacitively coupled to the first and second sense lines, wherein each of the plurality of drive lines can be split into a plurality of lines.

Some examples of the disclosure are directed to a method for detecting an object proximate to a touch panel, the method comprising: detecting a first capacitance value using a first sense line, the first capacitance value indicative of a proximity of the object to the touch panel; and detecting a second capacitance value using a second sense line, the second capacitance value indicative of the proximity of the object to the touch panel, wherein when the object can be located between the first and second sense lines, a ratio between the first capacitance value and the second capacitance value is less than 4. Additionally or alternatively to one or more of the examples disclosed above, the first sense line can be adjacent to the second sense line. Additionally or alternatively to one or more of the examples disclosed above, the first sense line can be split into a first plurality of lines, and the second sense line can be split into a second plurality of lines. Additionally or alternatively to one or more of the examples disclosed above, at least one of the first plurality of lines can be interleaved with at least one of the second plurality of lines. Additionally or alternatively to one or more of the examples disclosed above, at least one of the first plurality of lines can include a first plurality of extensions extending away from the at least one of the first plurality of lines, and at least one of the second plurality of lines can include a second plurality of extensions extending away from the at least one of the second plurality of lines.

Although examples have been fully described with reference to the accompanying drawings, it is to be noted that various changes and modifications will become apparent to those skilled in the art. Such changes and modifications are to be understood as being included within the scope of the various examples as defined by the appended claims.

What is claimed is:

1. A touch panel comprising:
a first sense line split into a first plurality of prongs, wherein at least one of the first plurality of prongs comprises a first plurality of extensions extending away from the at least one of the first plurality of prongs.

2. The touch panel of claim 1, further comprising a second sense line split into a second plurality of prongs, wherein at least one of the second plurality of prongs comprises a second plurality of extensions extending away from the at least one of the second plurality of prongs, and wherein the second plurality of extensions are interleaved with the first plurality of extensions.

3. The touch panel of claim 2, wherein each of the interleaved first plurality of extensions and second plurality of extensions are uniformly spaced.

4. The touch panel of claim 2, wherein the first plurality of extensions extend away from the at least one of the first plurality of prongs at a perpendicular angle, and wherein the second plurality of extensions extend away from the at least one of the second plurality of prongs at a perpendicular angle.

5. The touch panel of claim 3, wherein the first plurality of extensions extend away from the at least one of the first plurality of prongs at a perpendicular angle, and wherein the second plurality of extensions extend away from the at least one of the second plurality of prongs at a perpendicular angle.

6. The touch panel of claim 1, wherein the first sense line is split into only a first and a second prong, and the first prong has the first plurality of extensions extending along a first direction away from the first prong, and the second prong has a second plurality of extensions extending along a second direction, opposite the first direction, and extending away from the second prong.

7. The touch panel of claim 6, further wherein each of the first plurality of extensions are disposed equal distance between each of the second plurality of extensions.

8. The touch panel of claim 7, further comprising a second sense line split into only a first and second prong, and the first prong of the second sense line having a first plurality of extensions extending along the first direction away from the first prong of the second sense line, and the second prong having a second plurality of extensions extending along the second direction, and extending away from the second prong of the second sense line.

9. The touch panel of claim 8, wherein the first and second sense lines are disposed adjacent one another and the first plurality of extensions of the first prong of the first sense line are interleaved with the second plurality of extensions of the second prong of the second sense line.

10. The touch panel of claim 9, wherein the first plurality of extensions of the first prong of the first sense line are interleaved with the second plurality of extensions of the second prong of the second sense line in a uniform spacing.

11. The touch panel of claim 10, wherein the first prong and the second prong are joined at only one end.

12. The touch panel of claim 10, wherein the first plurality of extensions of the first prong of the first sense line extends away from the first prong at right angles and wherein the second plurality of extensions of the second prong of the first sense line extends away from the second prong at right angles.

13. The touch panel of claim 12, wherein the first plurality of extensions of the first prong of the second sense line extends away from the first prong at right angles and wherein the second plurality of extensions of the second prong of the second sense line extends away from the second prong at right angles.
